(19) United States
(12) Patent Application Publication
(10) Pub. No.: US 2012/0286954 A1
(43) Pub. Date: Nov. 15, 2012

(54) MOTION ALERT DEVICE, A MOTION ALERT ASSEMBLY AND A METHOD OF DETECTING MOTION

(76) Inventor: Thomas David Cullen, Kirknewton (GB)

(21) Appl. No.: 13/179,169

(22) Filed: Jul. 8, 2011

(30) Foreign Application Priority Data
May 10, 2011 (GB) 1107767.4

(51) Int. Cl. G08B 21/00

(52) U.S. Cl. 340/540

(57) ABSTRACT

A motion alert device comprising
at least one motion sensor;
a controller connected to the at least one motion sensor and adapted to generate an alert signal on detection of motion by the at least one motion sensor; and,
a touch switch adapted to switch the motion alert device between on and off states.

The present invention relates to a motion alert device, a motion alert assembly and a method of detecting motion. More particularly, but not exclusively, the present invention provides a motion alert device comprising a motion sensor, a controller for generating an alert signal on detection of motion by the motion sensor and a touch switch for switching the motion alert device between on and off states. In a further aspect the invention provides a motion alert device which is activated by an activation switch remote from the controller and connected thereto by a wired or wireless link. In a further aspect the invention provides a motion alert assembly comprising at least one motion alert device connected to a control hub. In a further aspect the present invention provides a method of detecting motion of a person by employing such a motion alert device.

Motion sensors can be useful in a variety of situations, for example retirement homes, hospitals private homes, hospices, care homes or controlled flats. Such sensors can be used to detect when a person such as a resident or patient leaves a seat or bed or exits their room. The sensor can then alert a member of staff. Typically a motion sensor comprises a pressure pad. The pressure pad is arranged on the seat or under the mattress of the bed of the patient. When the person leaves the seat or bed the pressure measured by the pressure pad drops. The pressure pad could alternatively be arranged by the side of the bed.

The use of pressure pads can be problematic. Patients can move the pressure pads if they do not want the staff to be alerted to their movement. If the pad is arranged on the floor the patient may simply avoid stepping on it.

An alternative type of motion sensor comprises a passive infra red sensor or similar device. In order to reduce false alarms this is typically arranged to cover a region of particular interest. It is only when a patient enters the region of interest that the motion sensor raises an alarm. A region of interest may be the floor at one or more sides of the patients bed. Alternatively/additionally it could be close to the entrance of the patients room.

Such sensors typically have controls which need to be set by hand. This can be a problem as a staff member must bend down to pick up the motion sensor, set it and then bend down again to arrange it in the correct position on the floor. This is not desirable in the workplace.

The motion alert device according to the invention seeks to overcome the problems of the prior art.

Accordingly, in a first aspect, the present invention provides a motion alert device comprising

at least one motion sensor;

a controller connected to the at least one motion sensor and adapted to generate an alert signal on detection of motion by the at least one motion sensor; and,

a touch switch adapted to switch the motion alert device between on and off states.

The motion alert device according to the invention can be turned on or off by simply touching the touch switch. A member of staff can therefore switch the device between on and off states by using a foot or other extremity. There is no need for the member of staff to bend down and pick up the device.

The touch switch can be a pressure switch.

The touch switch can be a heat switch.

The motion alert device can further comprise a housing for housing the controller;

the housing comprising an upper face, the touch switch being arranged on the upper face.

A portion of the upper face can comprise the touch switch.

In a further aspect of the invention there is provided a motion alert device comprising at least one motion sensor;

a controller connected to the at least one motion sensor and adapted to generate an alert signal on detection of motion by the at least one motion sensor; and,

an activation switch remote from the controller and connected thereto by a link and being adapted to switch the motion alert device between on and off states.

The link can be a wired link.

The link can be a wireless link, preferably Bluetooth.

The at least one motion sensor can comprise at least one of an infra red sensor, an ultrasonic sensor or a microwave sensor.

The motion alert device can comprise a plurality of motion sensors.

The motion alert device can further comprise a pressure sensor connected to the controller;

the controller being adapted to generate an alert signal when the pressure measured by the pressure sensor changes.

The motion alert device can further comprise an alarm connected to the controller, the alarm being adapted to be activated on receipt of an alert signal from the controller.

The motion alert device can further comprise at least one of a camera or microphone.

In a further aspect of the invention there is provided a motion alert assembly comprising

at least one motion alert device as claimed in any one of claims 1 to 13; and,

a control hub connected to the at least one motion alert device and adapted to receive the alert signal from the at least one motion alert device.

The control hub can be connected to the at least one motion alert device by a wired link.

The control hub can be connected to the at least one motion alert device by a wireless link, preferably Bluetooth.

The control hub can be adapted to receive the signal from the microphone or camera of the motion alert device.

The motion alert assembly can further comprise at least one of an audio or video intercom between the control hub and motion alert device.

In a further aspect of the invention there is provided a method of detecting motion of a person comprising the steps of

(a) providing a motion alert device as claimed in any one of claims 1 to 13;

(b) arranging the device to detect motion in a region of interest proximate to the person; and,

(c) switching the motion alert device to the on state.

The region of interest can be proximate to at least one side of a bed.

The present invention will now be described by way of example only and not in any limitative sense with reference to the accompanying drawings in which

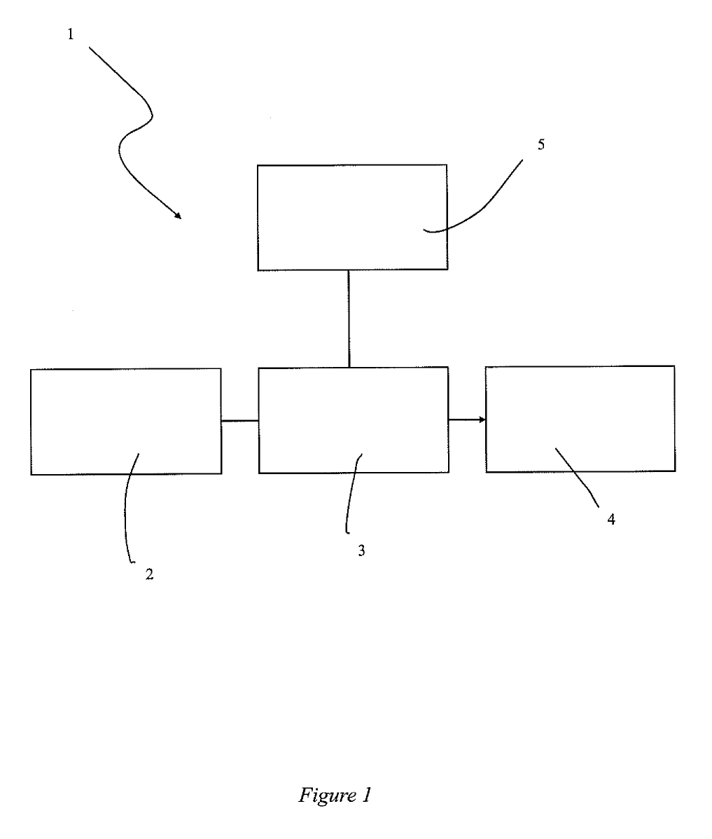

FIG. 1 shows, in schematic form, a motion alert device according to the invention;

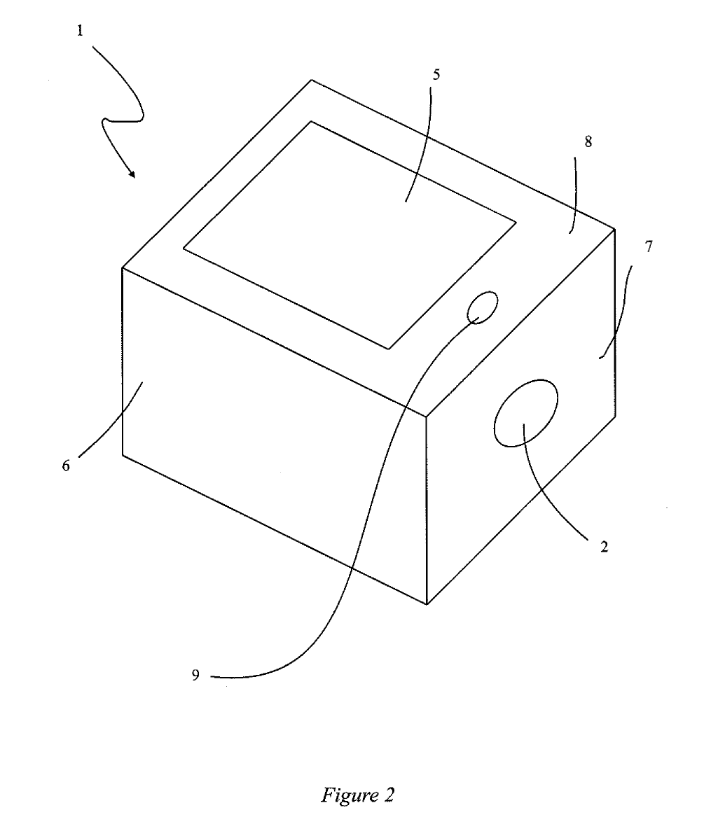

FIG. 2 shows, in perspective view, the motion alert device of FIG. 1;

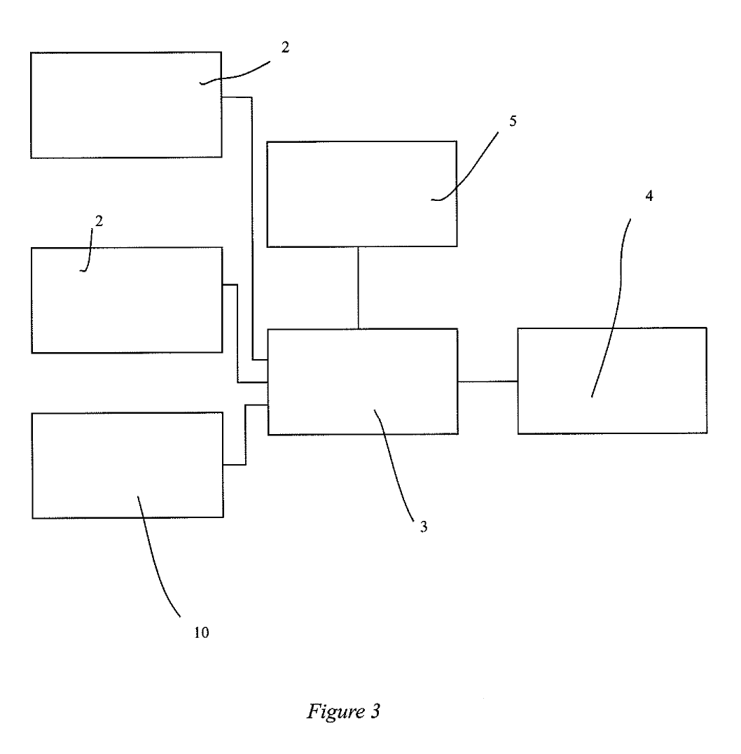

FIG. 3 shows, in schematic form, a further embodiment of a motion alert device according to the invention;

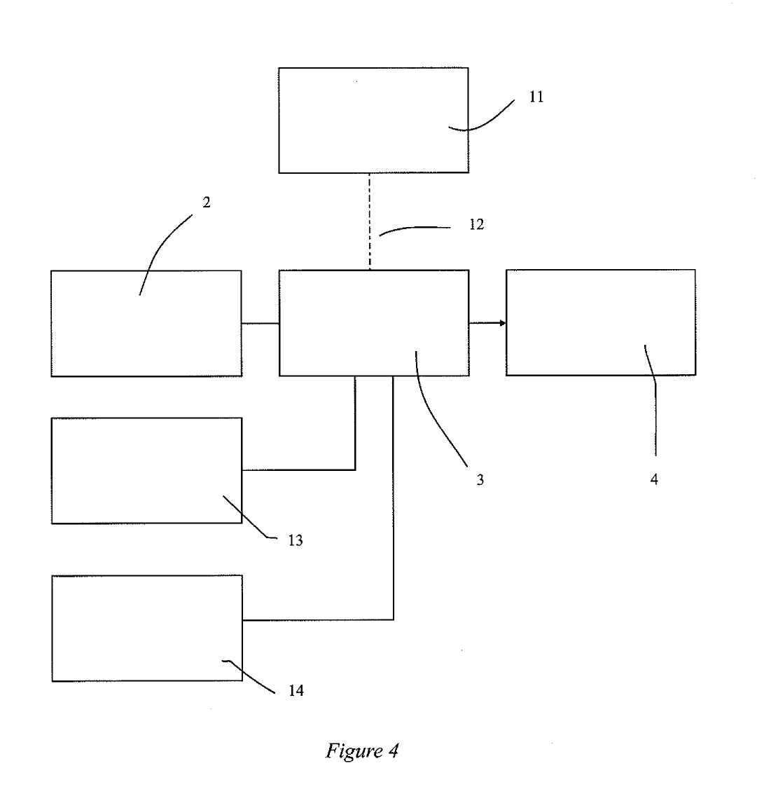

FIG. 4 shows, in schematic form, a further embodiment of a motion alert device according to the invention; and,

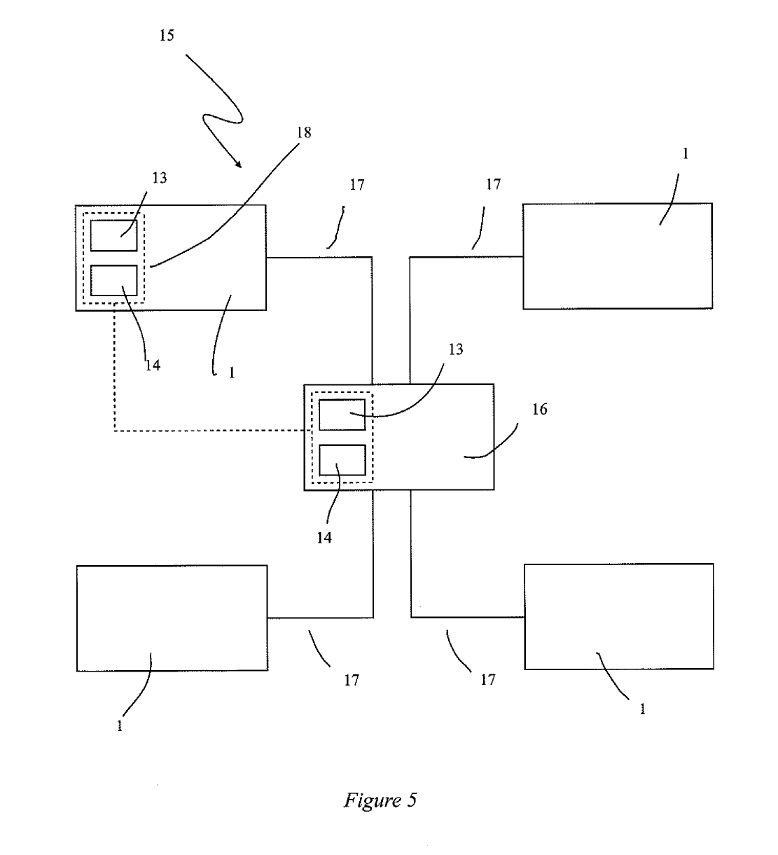

FIG. 5 shows, in schematic view, a motion alert assembly according to the invention.

FIG. 1 shows, in schematic form, a motion alert device 1 according to the invention. The motion alert device 1 comprises a motion sensor 2. The motion sensor 2 of this embodiment is a passive infra red device. The motion sensor 2 is connected to a controller 3 which is in turn connected to an alarm 4. A touch switch 5 is connected to the controller 3 and is used to switch the motion alert device 1 between on and off states. In this embodiment the touch switch 5 is a pressure switch activated by applying pressure to the switch 5, for example by a foot.

FIG. 2 shows the motion alert device 1 of FIG. 1 in perspective view. The controller 3 is contained within a housing 6. The motion sensor 2 extends through a side wall 7 of the housing 6 as shown. The touch switch 5 in this embodiment is a portion of an upper face 8 of the housing 6. The upper face 8 is therefore substantially smooth which aids cleaning. In an alternative embodiment the touch switch 5 is upstanding from the upper face 8.

In use the motion alert device 1 is arranged with the motion sensor 2 covering a region of interest. A member of staff switches the motion alert device 1 into the on configuration by pressing the touch switch 5 with a foot. If the patient moves in the region of interest the motion sensor 2 sends a signal to the controller 3. The controller 3 in turn sends a signal to the in-built alarm 4 which is then activated. Typically the device 1 is adapted so that there is a delay between the motion alert device 1 being switched on and it entering the on state. This gives the member of staff time to leave the room if necessary. In this embodiment the motion alert device 1 includes an LED 9 which flashes during this delay.

If the alarm sounds then the member of staff must press the touch switch 5 again to reset the motion alert device 1. If the motion alert device 1 is in the on state then pressing the foot switch 5 will switch the motion alert device 1 into the off state. In the off state the alarm 4 will not sound when the patient enters the area of interest.

A typical area of interest is at one or more sides of the bed. When a patient leaves the bed and places a foot at the side of the bed this activates the motion alert device 1. A further common region of interest is near the entrance to the patients room.

The motion alert device 1 according to the invention can be operated by the foot only. There is no need for a member of staff to bend down and pick the device 1 up. This considerably simplifies operation. It can also be used by people who are unable to bend down easily, typically elderly patients or those recovering from surgery. In addition, the device 1 is typically powered by an internal power supply such as a rechargeable battery or the like (in alternative embodiments mains power is possible). The device 1 can therefore be positioned by pushing it around the floor with the foot as required.

In the above embodiment the motion sensor 2 is a passive infra-red device. In alternative embodiments the motion sensor 2 is an ultrasonic or microwave sensor.

In alternative embodiments of the invention the motion alert device 1 comprises a plurality of motion sensors 2. This has the advantage of reducing false alarms.

In an alternative embodiment the touch switch 5 is a heat switch. The switch is activated by a change in temperature, for example by the body heat of a member of staff.

Shown in FIG. 3 in schematic form is a further embodiment of the device 1 according to the invention in schematic form. This embodiment further comprises a pressure pad 10 connected to the controller 3. When the pressure pad 10 detects a change in pressure it sends a signal to the controller 3 which in turn activates the alarm 4 as before. The pressure pad 10 is typically placed on the patients chair to detect when the patient leaves the chair. Alternatively it could be placed under the patients mattress or by the side of the bed.

In the embodiment shown in FIG. 3 connecting the pressure pad 10 to the controller 3 automatically disables the motion sensor 3. In alternative embodiments both the pressure sensor and motion sensor may detect motion in parallel. In a further embodiment of the invention the device 1 includes a control for determining the behaviour of the device 1 when the pressure pad 10 is plugged in. This embodiment includes a plurality of motion sensors 2.

Shown in FIG. 4 is a further embodiment of a motion alert device according to the invention. As before the motion alert device comprises a motion sensor 2 which is connected to a controller 3 which is in turn connected to an alarm 4. Also connected to the controller 3 but remote therefrom is an activation switch 11. In this embodiment the activation switch 11 is connected by a wireless link 12, preferably Bluetooth. The activation switch is contained within a key fob. The member of staff can switch the motion alert device 1 between on and off states by pressing the key fob. There is no need to bend down. In an alternative embodiment the link 12 can be a wired link.

The embodiment shown in FIG. 4 further comprises a microphone 13 and camera 14. The motion alert device may activate these and send audio and/or video signals to a remote monitor as is discussed in more detail with reference to FIG. 5. The microphone 13 and/or camera 14 may be activated automatically on detection of motion. Alternatively/additionally they could be activated by the remote monitor.

Shown in FIG. 5 in schematic form is a motion alert assembly 15 according to the invention. The motion alert assembly 15 comprises a plurality of motion alert devices 1 according to the invention. The motion alert devices 1 are connected to a control hub 16 as shown. In use the motion alert devices 1 are positioned in the rooms of a number of different patients. The control hub 16 is positioned at a nurses station or similar.

In the embodiment shown in FIG. 5 the motion alert devices 1 are connected to the control hub 16 by a wireless link 17. In this embodiment this is a Bluetooth link. When motion is detected the controller 3 of the motion alert device 1 sends an alert signal to the control hub 16 where an alert is activated. In order to reset the system the member of staff must press the foot switch 5 on the top of the motion alert device 1 which sent the signal to the control hub 16.

One of the motion alert devices 1 includes a microphone 13 and camera 14. When motion is detected the microphone 13 and camera 14 send signals over the wireless link 17 to the control hub 16. The control hub 16 may also be used to activate the microphone 13 and/or camera 14 when required even if motion is not detected.

The assembly also comprises an intercom 18 between the motion alert device 1 and control hub 16. The intercom uses the microphone 13 and camera 14 of the motion alert device 1 and also a microphone 13 and camera 14 at the control hub 16. The intercom allows the member of staff to view and speak to the patient without leaving the control hub 16.

It is preferred that the motion alert device 1 can only be reset locally. The member of staff must therefore visit the patient. In an alternative embodiment the motion alert device 1 can be reset from the control hub 16.

In an alternative embodiment of the motion alert assembly 15 according to the invention the motion alert devices 1 are connected to the control hub over a wired network.

1. A motion alert device comprising:
at least one motion sensor;
a controller connected to the at least one motion sensor and adapted to generate an alert signal on detection of motion by the at least one motion sensor; and,
a touch switch adapted to switch the motion alert device between on and off states.

2. A motion alert device as claimed in claim 1, wherein the touch switch is a pressure switch.

3. A motion alert device as claimed in claim 1, wherein the touch switch is a heat switch.

4. A motion alert device as claimed in claim 1, further comprising a housing for housing the controller; with the housing comprising an upper face, and the touch switch being arranged on the upper face.

5. A motion alert device as claimed in claim 4, wherein a portion of the upper face comprises the touch switch.

6. A motion alert device comprising:
at least one motion sensor;
a controller connected to the at least one motion sensor and adapted to generate an alert signal on detection of motion by the at least one motion sensor; and
an activation switch remote from the controller and connected thereto by a link and being adapted to switch the motion alert device between on and off states.

7. A motion alert device as claimed in claim 6, wherein the link is a wired link.

8. A motion alert device as claimed in claim 6, wherein the link is a wireless link.

9. A motion alert device as claimed in claim 1, wherein the at least one motion sensor comprises at least one of an infra red sensor, an ultrasonic sensor or a microwave sensor.

10. A motion alert device as claimed in claim 1, comprising a plurality of motion sensors.

11. A motion alert device as claimed in claim 1, further comprising a pressure sensor connected to the controller with the controller being adapted to generate an alert signal when the pressure measured by the pressure sensor changes.

12. A motion alert device as claimed in claim 1, further comprising an alarm connected to the controller, the alarm being adapted to be activated on receipt of an alert signal from the controller.

13. A motion alert device as claimed in claim 1, further comprising at least one of a camera or a microphone.

14. A motion alert assembly comprising:
at least one motion alert device including;
at least one motion sensor,
a controller connected to the at least one sensor and adapted to generate an alert signal on detection of motion by the at least one motion sensor,
a switch adapted to switch the motion alert device between on and off states, and
with the motion alert assembly further comprising a control hub connected to the at least one motion alert device and adapted to receive the alert signal from the at least one motion alert device.

15. A motion alert assembly as claimed in claim 14, wherein the control hub is connected to the at least one motion alert device by a wired link.

16. A motion alert device as claimed in claim 14, wherein the control hub is connected to the at least one motion alert device by a wireless link.

17. A motion alert assembly as claimed in claim 14, wherein the motion alert device further comprises a pressure sensor connected to the controller; the controller being adapted to generate an alert signal when the pressure measured by the pressure sensor changes, with the control hub being adapted to receive the signal from the motion alert device.

18. A motion alert assembly as claimed in claim 14, further comprising at least one of an audio or video intercom between the control hub and motion alert device.

19. A method of detecting motion of a person comprising the steps of:
(a) providing a motion alert device;
(b) arranging the device to detect motion in a region of interest proximate to the person; and,
(c) switching the motion alert device to the on state.

20. A method as claimed in claim 19, wherein the region of interest is proximate to at least one side of a bed.
